(19) United States
(12) Patent Application Publication
(10) Pub. No.: US 2026/0184981 A1
(43) Pub. Date: Jul. 2, 2026

(54) HEAT-CONDUCTIVE SHEET, AND METHOD FOR PRODUCING HEAT-CONDUCTIVE SHEET

(71) Applicant: KANEKA CORPORATION, Osaka (JP)

(72) Inventor: Yasushi NISHIKAWA, Tokyo (JP)

(73) Assignee: KANEKA CORPORATION, Osaka (JP)

(21) Appl. No.: 19/182,883

(22) Filed: Apr. 18, 2025

(30) Foreign Application Priority Data
Apr. 26, 2024 (JP) 2024-072642

(51) Int. Cl. C09K 5/14; C08J 5/18; C08K 3/04; C08K 3/32; C08K 5/523

(52) U.S. Cl. CPC C09K 5/14; C08J 5/18; C08K 3/04; C08K 3/32; C08J 2333/04; C08K 5/523; C08K 2201/001

(57) ABSTRACT

A thermally conductive sheet containing a composition that contains graphite particles (A) and an organic polymer compound (B) which contains an acrylic ester-based resin containing a carboxyl group in an amount of 0.010 mmol/g to 0.410 mmol/g, the graphite particles (A) being oriented in a thickness direction of the thermally conductive sheet is provided as a thermally conductive sheet that has high graphite binding capacity and excellent adhesion to an adherend.

This Nonprovisional application claims priority under 35 U.S.C. § 119 on Patent Application No. 2024-072642 filed in Japan on Apr. 26, 2024, the entire contents of which are hereby incorporated by reference.

### TECHNICAL FIELD

The present invention relates to a thermally conductive sheet and a method for producing a thermally conductive sheet.

### BACKGROUND ART

A technique for preventing or reducing temperature increases by attaching a heat-dissipating body to a heat-generating body such as an electronic component is conventionally known. In a case where this heat-dissipating body is used, a member that is in sheet form and that has thermal conductivity (thermally conductive sheet) is used to efficiently transmit heat from the heat-generating body to the heat-dissipating body. Further, the thermally conductive sheet is required to be also so flexible as to be capable of adhering to an adherend.

A thermally conductive sheet containing a composition containing graphite particles and an organic polymer compound, the graphite particles being oriented in a thickness direction of the thermally conductive sheet, is known as a thermally conductive sheet that has high thermal conductivity and that is so flexible as to be capable of adhering to an adherend (see, for example, Patent Literatures 1 to 3).

### CITATION LIST

### Patent Literature

### [Patent Literature 1]

Pamphlet of International Publication NO. WO 2008/053843

### [Patent Literature 2]

Japanese Patent Application Publication, Tokukai, No. 2010-132856

### [Patent Literature 3]

Japanese Patent Application Publication, Tokukai, No. 2011-184663

### SUMMARY OF INVENTION

### Technical Problem

However, conventional thermally conductive sheets containing a composition containing graphite particles and an organic polymer compound, such as thermally conductive sheets disclosed in Patent Literatures 1 to 3 have room for improvement in terms of graphite binding capacity and adhesion to an adherend.

Thus, an aspect of the present invention has an object to provide a thermally conductive sheet that has excellent graphite binding capacity and excellent adhesion to an adherend.

### Solution to Problem

In order to attain the object, a thermally conductive sheet in accordance with an embodiment of the present invention is a thermally conductive sheet containing a composition containing graphite particles (A) and an organic polymer compound (B),
the graphite particles (A) being oriented in a thickness direction of the thermally conductive sheet,
the organic polymer compound (B) containing an acrylic ester-based resin having a carboxyl group, and
a content of the carboxyl group in the organic polymer compound (B) relative to a total weight of the organic polymer compound (B) being not less than 0.010 mmol/g and not more than 0.410 mmol/g.

In order to attain the object, a method for producing a thermally conductive sheet in accordance with an embodiment of the present invention includes: a primary sheet forming step of forming, in sheet form, a composition containing graphite particles (A) and an organic polymer compound (B), to obtain a primary sheet in which the graphite particles (A) are oriented in a direction parallel to a sheet surface;
a laminate forming step of laminating the primary sheet to obtain a primary sheet laminate; and
a slicing step of slicing a laminate cross section of the primary sheet laminate to obtain a thermally conductive sheet,
the organic polymer compound (B) containing an acrylic ester-based resin having a carboxyl group, and
a content of the carboxyl group in the organic polymer compound (B) relative to a total weight of the organic polymer compound (B) being not less than 0.010 mmol/g and not more than 0.410 mmol/g.

### Advantageous Effects of Invention

An aspect of the present invention makes it possible to provide a thermally conductive sheet that has excellent graphite binding capacity and excellent adhesion to an adherend.

### DESCRIPTION OF EMBODIMENTS

The following description will discuss embodiments of the present invention. The present invention is not, however, limited to these embodiments. The present invention is not limited to the configurations described below, but may be altered in various ways within the scope of the claims. The present invention also encompasses, in its technical scope, any embodiment or example derived by combining technical means disclosed in differing embodiments or examples. Further, it is possible to form a new technical feature by combining the technical means disclosed in the respective embodiments. Note that all academic documents and patent literatures cited herein are incorporated herein by reference. Any numerical range expressed as “A to B” herein means “not less than A and not more than B (i.e., a range from A to B which includes both A and B)” unless otherwise stated.

### [1. Thermally Conductive Sheet]

A thermally conductive sheet in accordance with an embodiment of the present invention (hereinafter also referred to as “thermally conductive sheet of an aspect of the present invention”) is a thermally conductive sheet containing a composition containing graphite particles (A) and an organic polymer compound (B), the graphite particles (A) being oriented in a thickness direction of the thermally conductive sheet, the organic polymer compound (B) containing an acrylic ester-based resin having a carboxyl group, and a content of the carboxyl group in the organic polymer compound (B) relative to a total weight of the organic polymer compound (B) being not less than 0.010 mmol/g and not more than 0.410 mmol/g.

### [1-1. Composition Containing Graphite Particles (A) and Organic Polymer Compound (B)]

### (Graphite Particles (A))

A thermally conductive sheet of an aspect of the present invention a composition containing graphite particles (A) and an organic polymer compound (B). The thermally conductive sheet containing the graphite particles (A) allows the graphite particles (A) that have thermal conductivity to be dispersed in the thermally conductive sheet. Thus, the thermally conductive sheet can have higher thermal conductivity. This makes it possible to reduce thermal resistance of the thermally conductive sheet.

The graphite particles (A) may have a shape that is either spherical or non-spherical. From the viewpoint that the graphite particles (A) being easily oriented makes it possible to improve thermal conductivity in an orientation direction in which the graphite particles (A) are oriented, so that thermal resistance in the orientation direction can be reduced, the thermally conductive sheet preferably contains the graphite particles (A) having a non-spherical shape. Note that only one type of graphite particles (A) may be used, or two or more types of graphite particles (A) may be used in combination.

The graphite particles (A) having a non-spherical shape have a shape that is not particularly limited. For example, the shape can be a plate-like shape such as a scale-like shape or a flaky shape; a spheroidal shape; a needle shape; a rod shape; a fibrous shape; or an irregular shape. Among these, the shape is more preferably a plate-like shape such as a scale-like shape or a flaky shape. In a case where the graphite particles (A) having a non-spherical shape have a plate-like shape, the graphite particles (A) are easily oriented, and a contact between particles is also easily maintained. This makes it possible to further improve thermal conductivity in the orientation direction, so that thermal resistance in the orientation direction can be further reduced.

In the present specification, “spherical shape” means a perfect spherical shape or a spheroidal shape having an aspect ratio of 1.0 to 1.5, in other words, a perfect spherical shape having an aspect ratio of 1.0 or a spheroidal shape having an aspect ratio of more than 1.0 and not more than 1.5, and does not necessarily need to be a perfect spherical shape. Note that the aspect ratio in a case where the graphite particles (A) have a “spherical shape” means a ratio represented by the major axis/the minor axis. Further, “non-spherical shape” means a shape different from the “spherical shape”, i.e., a shape having an aspect ratio of more than 1.5. Note that “spheroidal shape” means an ellipsoidal shape obtained by rotating an ellipse, such as a rugby ball.

In the graphite particles (A) having a “non-spherical shape”, the aspect ratio means a ratio of a maximum length to a minimum length (maximum length/minimum length) of the graphite particles (A). For example, in a case where the shape is a plate-like shape, the aspect ratio is a ratio of the maximum length to a thickness (maximum length/thickness) of the graphite particles (A). The aspect ratio can be determined as follows. Specifically, a sufficient number of (e.g., not less than 10) graphite particles (A) are observed with a scanning electron microscope, the major axis/the minor axis or the maximum length/the minimum length of each of the graphite particles (A) is calculated, and the aspect ratio is determined as an average of the calculated major axis/minor axis or the calculated maximum length/minimum length.

In a case where two or more types of graphite particles (A) are used, the aspect ratio is an average aspect ratio calculated by performing weighted average calculation on aspect ratios of the respective types of graphite particles (A).

The graphite particles (A) used in an embodiment of the present invention can be, for example, particles of, for example, scale-like graphite, scaly graphite, earthy graphite, artificial graphite, flaky graphite, acid-treated graphite, expanded graphite, or carbon fiber flakes.

A sulfur content in the graphite particles (A) is preferably not more than 1.0% by weight, more preferably not more than 0.7% by weight, and even more preferably not more than 0.5% by weight. The sulfur content being not more than 1.0% by weight makes it possible to suitably prevent corrosion of an electronic component that is in contact with the thermally conductive sheet. The corrosion is caused by sulfur being leached out as an acid, the sulfur being contained as an impurity in the graphite particles (A).

The graphite particles (A) have an average particle size of preferably 20 μm to 1,000 μm, more preferably 30 μm to 500 μm, and particularly preferably 40 μm to 240 μm. Note here that the average particle size of the graphite particles (A) is a value determined by a laser diffraction/scattering particle size distribution analyzer (LA-920, manufactured by HORIBA, Ltd.).

In a case where the graphite particles (A) have an average particle size of not less than 20 μm, it is easy for the graphite particles (A) to be oriented in a desired direction in the thermally conductive sheet to form a good heat transfer path. Further, in a case where an upper limit of the average particle size of the graphite particles (A) is in the foregoing range, the graphite particles are exposed on a surface of the thermally conductive sheet. This allows heat transfer from a heat-generating body to the thermally conductive body to be better when the thermally conductive sheet is brought into contact with the heat-generating body.

### (Organic Polymer Compound (B))

The composition contains the organic polymer compound (B). The organic polymer compound (B) not only functions as a binder but also makes it possible to improve flexibility of the thermally conductive sheet and allow good adhesion between a heat-generating body and a heat-dissipating body via the thermally conductive sheet.

The organic polymer compound (B) contains an acrylic ester-based resin having a carboxyl group (—COOH group). The organic polymer compound (B) may contain one or two or more types of the acrylic ester-based resin having the carboxyl group. Thus, the organic polymer compound (B) contains a carboxyl group.

In the thermally conductive sheet of an aspect of the present invention, a content of the carboxyl group in the organic polymer compound (B) relative to a total weight of the organic polymer compound (B) is not less than 0.010 mmol/g and not more than 0.410 mmol/g.

In a case where the content of the carboxyl group in the organic polymer compound (B) relative to the total weight of the organic polymer compound (B) (hereinafter also referred to as “content of the carboxyl group of an aspect of the present invention”) is not less than 0.010 mmol/g, it is possible to improve graphite binding capacity of the thermally conductive sheet. This is considered to be because the carboxyl group contained in the organic polymer compound (B) acts on the graphite particles (A) to function as a binder for binding a plurality of graphite particles (A). Thus, the thermally conductive sheet of an aspect of the present invention has excellent graphite binding capacity.

Using, as an organic polymer compound, the organic polymer compound (B) having the carboxyl group makes it possible to improve graphite binding capacity as described earlier. However, it has turned out that a thermally conductive sheet obtained by laminating a sheet formed from a composition containing the graphite particles (A) and the organic polymer compound (B) having the carboxyl group sometimes has low adhesion to an adherend. The inventors of the present invention have found that this is due to the following: The thermally conductive sheet is ordinarily attached while heat is being applied thereto. Further, when the thermally conductive sheet is used, heat is applied from a heat-generating body, which is the adherend, and water that has been absorbed by the heat is discharged to the outside. This changes the shape of the thermally conductive sheet. Then, as a result of diligent research, the inventors of the present invention have found that a thermally conductive sheet which has excellent adhesion to an adherend can be achieved by causing the content of the carboxyl group in the organic polymer compound (B) relative to the total weight of the organic polymer compound (B) to be not more than a predetermined amount. It is considered that this is due to the following: In a case where the content of the carboxyl group in the thermally conductive sheet is excessively high, the carboxyl group easily acts on a water molecule. This causes the thermally conductive sheet to be in a state of having high moisture absorbency and having absorbed a large amount of water from the air. In that case, it is inferred that a large amount of water discharged increases a degree of the aforementioned change in shape, so that adhesion to the adherend tends to decrease due to production of a gap between the thermally sheet and the adherend. The thermally conductive sheet of an aspect of the present invention also has excellent adhesion to an adherend. This is because the content of the carboxyl group of an aspect of the present invention is not more than 0.410 mmol/g, and the content of the carboxyl group is not excessively high.

The carboxyl group acts on a substance of which a surface of the adherend is made, and contributes to adhesion between the thermally conductive sheet and the adherend. Thus, in a case where the content of the carboxyl group of an aspect of the present invention is not less than 0.010 mmol/g, it is possible to improve tackiness during adhesion of the thermally conductive sheet to the adherend. The thermally conductive sheet of an aspect of the present invention is therefore also excellent in the tackiness.

In order to further improve graphite binding capacity, the content of the carboxyl group of an aspect of the present invention is preferably not less than 0.050 mmol/g, and more preferably not less than 0.090 mmol/g. The content of the carboxyl group of an aspect of the present invention can be expressed not only in a unit of “mmol/g” but also in a unit of “KOHmg/g”, which is commonly used. In that case, the content of the carboxyl group of an aspect of the present invention is not less than 0.56 KOHmg/g, preferably not less than 2.81 KOHmg/g, and more preferably not less than 5.05 KOHmg/g.

In order to further improve adhesion to the adherend, the content of the carboxyl group of an aspect of the present invention is preferably not more than 0.380 mmol/g, and more preferably not more than 0.350 mmol/g. The content of the carboxyl group of an aspect of the present invention which content is expressed in the unit of “KOHmg/g” is not more than 23.00 KOHmg/g, preferably not more than 21.32 KOHmg/g, and more preferably not more than 19.64 KOHmg/g.

Note that conversion from mmol/g to KOHmg/g is calculated by multiplying mmol/g by 56.1056 mg/mmol.

A method for measuring the content of the carboxyl group of an aspect of the present invention is exemplified by, but not particularly limited to, a method including steps (1) to (3) below.

(1) A known method is used to extract the organic polymer compound (B) from the thermally conductive sheet and measure a total weight (unit: g) of the extracted organic polymer compound (B).
(2) ¹HNMR, for example is used to measure a substance amount (unit: mmol) of the carboxyl group in the organic polymer compound (B) extracted in step (1).
(3) The content (unit: mmol/g) of the carboxyl group of an aspect of the present invention is calculated by dividing, by the total weight of the organic polymer compound (B) which total weight has been measured in step (1), the content (the number of moles) of the carboxyl group in the organic polymer compound (B) which content has been measured in step (2).

Assume that weight average molecular weights of all polymers contained in the organic polymer compound (B), a content of a monomer having the carboxyl group in all monomers constituting the polymers, and a content ratio of each of the polymers are known. In this case, on the basis of those, the content of the carboxyl group of an aspect of the present invention can also be calculated.

A content of the acrylic ester-based resin having the carboxyl group relative to the total weight of the organic polymer compound (B) is preferably not less than 15% by weight, more preferably not less than 20% by weight, even more preferably not less than 35% by weight, and particularly preferably not less than 40% by weight. For example, the content of the acrylic ester-based resin content can be 100% by weight, may be not more than 95% by weight, or is preferably not more than 90% by weight, relative to the total weight of the organic polymer compound (B).

The organic polymer compound (B) can contain another organic polymer compound that is different from the acrylic ester-based resin having the carboxyl group.

The another organic polymer compound is not particularly limited and can be an organic polymer compound that ordinarily used in a thermally is conductive sheet. The another organic polymer compound may be one resin or may be a mixture of two or more resins.

Examples of the another organic polymer compound include an acrylic ester-based resin which has no carboxyl group, a resin the main chain of which consists of repeated siloxane bonds (silicone resin), a resin which has rubber elasticity at room temperature (elastomer resin), an epoxy resin, a fluorine resin, polyolefin, polyvinyl chloride, polyvinylidene chloride, polyvinyl acetate, an ethylene-vinyl acetate copolymer, polyvinyl alcohol, polyacetal, polyethylene terephthalate, polybutylene terephthalate, polyethylene naphthalate, polystyrene, polyacrylonitrile, polyphenylene ether, modified polyphenylene ether, aliphatic polyamides, aromatic polyamides, polyamideimide, polycarbonate, polyphenylene sulfide, polysulfone, polyether sulfone, polyether nitrile, polyether ketone, polyketone, polyurethane, a liquid crystal polymer, and ionomer.

In a case where the organic polymer compound (B) contains an epoxy resin as the another organic polymer compound, a content of the epoxy resin is preferably less than 6.5 parts by weight relative to 100 parts by weight of the acrylic ester-based resin having the carboxyl group.

The organic polymer compound (B) may be either solid or liquid at normal temperature. Note that “normal temperature” refers to 20° C. in the present specification.

The acrylic ester-based resin having the carboxyl group preferably has not less than 50% by weight of a repeating unit derived from an acrylic monomer. The acrylic ester-based resin having the carboxyl group includes a polymer at least some of monomers of which have a carboxyl group and whose monomer component contains at least one type of acrylic monomer. The acrylic ester-based resin having the carboxyl group also includes a copolymer at least some of monomers of which have a carboxyl group and which is composed of an acrylic monomer and another monomer. The acrylic monomer is at least one type of monomer selected from (meth)acrylic acids and (meth)acrylic esters. Note here that “(meth)acrylic” intends to include both “methacrylic” and “acrylic” in the present specification. Examples of the (meth)acrylic ester (b2) include (meth)acrylic esters having esters having 1 to 10 carbon atoms, such as methyl (meth)acrylate, ethyl (meth)acrylate, n-butyl (meth)acrylate, isobutyl (meth)acrylate, 2-ethylhexyl (meth)acrylate, and cyclohexyl (meth)acrylate.

Examples of the another monomer (b3) include acrylonitrile, glycidyl methacrylate, and 2-chloroethylvinyl ether. The another monomer may be one type of monomer or two or more types of monomers. Note that acrylic rubber is obtained by copolymerizing (meth)acrylic ester with, for example, acrylonitrile and 2-chloroethylvinyl ether. In the present specification, the acrylic rubber is considered to be included in an acrylic ester-based resin.

The percentage of the weight of a monomer having the carboxyl group to the weight of all monomers constituting all polymer compounds (polymers) included in the organic polymer compound (B) is preferably 0.1% by weight to 5.2% by weight, and more preferably 0.3% by weight to 4.0% by weight. Further, the percentage of the substance amount (number of moles) of a monomer having the carboxyl group to the substance amount (number of moles) of all monomers constituting all polymer compounds (polymers) included in the organic polymer compound (B) is preferably 0.1 mol % to 5.2 mol %, and more preferably 0.3 mol % to 4.0 mol %. It is preferable to adjust the above percentages in the foregoing ranges in order to suitably control the content of the carboxyl group of an aspect of the present invention in the foregoing range.

The percentage of the weight of a monomer having the carboxyl group to the weight of all monomers constituting the acrylic ester-based resin having the carboxyl group and contained in the organic polymer compound (B) is preferably 0.1% by weight to 5.2% by weight, and more preferably 0.3% by weight to 4.0% by weight. Further, the percentage of the substance amount (number of moles) of a monomer having the carboxyl group to the substance amount (number of moles) of all monomers constituting the acrylic ester-based resin having the carboxyl group and contained in the organic polymer compound (B) is preferably 0.1 mol % to 5.2 mol %, and more preferably 0.3 mol % to 4.0 mol %. It is preferable to adjust the above percentages in the foregoing ranges in order to suitably control the content of the carboxyl group of an aspect of the present invention in the foregoing range.

The monomer (b1) having the carboxyl group is not particularly limited, and preferable examples thereof include acrylic acids and methacrylic acids. The monomer (b1) having the carboxyl group may be one type of monomer or two or more types of monomers.

The weight ratio among the monomer (b1) having the carboxyl group, the (meth)acrylic ester (b2), and the another monomer (b3) ((b1)/(b2)/(b3)) is preferably 0.1 to 5.2/99.9 to 79.8/0 to 15. Alternatively, the weight ratio ((b1)/(b2)/(b3)) may be, for example, in a range of 5 to 15/95 to 60/0 to 25.

The acrylic ester-based resin having the carboxyl group may be formed of a random copolymer or a block copolymer. Note, however, that a random copolymer is more preferable due to its availability.

The acrylic ester-based resin having the carboxyl group may have a linear or branched structure. Note, however, that a linear structure is more preferable due to its availability.

The organic polymer compound (B) is preferably dissolved in an organic solvent.

The acrylic ester-based resin having the carboxyl group may or need not include a crosslinked structure as long as flexibility is not impaired. The crosslinked structure being included in the acrylic ester-based resin having the carboxyl group is preferable in terms of long-term adhesion retention and film strength. The crosslinked structure can be included by, for example, reacting a compound having an isocyanate group with a polymer having a —OH group. Alternatively, the crosslinked structure can be included by, for example, reacting a compound having an epoxy group with a polymer having a —COOH group. However, in a case where the compound having an epoxy group is reacted with the polymer having a —COOH group, the —COOH group is consumed by such a reaction. Thus, in that case, it is necessary to be careful to prevent the content of the carboxyl group from being reduced to less than 0.01 mmol/g. In the following description, compounds that can form a crosslinked structure by reacting with functional groups (e.g., a —OH group and a —COOH group) contained in the organic polymer compound (B), such as the compound having an isocyanate group and the compound having an epoxy group are each referred to as “crosslinking agent”. In a case where the “crosslinking agent” is used, the crosslinking agent is preferably used in an amount of less than 5 parts by weight relative to 100 parts by weight of the organic polymer compound (B).

The organic polymer compound (B) has a weight average molecular weight of preferably not less than 100,000, more preferably not less than 400,000, and even more preferably not less than 600,000. The organic polymer compound (B) having a weight average molecular weight of as high as not less than 100,000 makes it difficult for the organic polymer compound (B) to flow (i) when a press plate is released after hot pressing at the time of bonding of the thermally conductive sheet of an aspect of the present invention and an adherend and (ii) when an external force is applied to the thermally conductive sheet of an aspect of the present invention after the thermally conductive sheet of an aspect of the present invention is attached. This allows the thermally conductive sheet of an aspect of the present invention to have higher adhesion to an adherend.

The organic polymer compound (B) has a weight average molecular weight of preferably not more than 3,000,000, more preferably not more than 2,000,000, and even more preferably not more than 1, 500,000. In a case where the organic polymer compound (B) has a weight average molecular weight of not more than 3,000,000, it is easy for the organic polymer compound (B) to flow during attachment of the thermally conductive sheet of an aspect of the present invention in a hot press machine. This allows the thermally conductive sheet of an aspect of the present invention to have higher wettability to an adherend bonded thereto and have higher adhesion to the adherend.

The acrylic ester-based resin having the carboxyl group has a weight average molecular weight of preferably not less than 100,000, more preferably not less than 400,000, and even more preferably not less than 600,000. In a case where the acrylic ester-based resin having the carboxyl group has a weight average molecular weight of as high as not less than 100,000, it is difficult for the organic polymer compound (B) to flow (i) when a press plate is released after hot pressing at the time of bonding of the thermally conductive sheet of an aspect of the present invention and an adherend and (ii) when an external force is applied to the thermally conductive sheet of an aspect of the present invention after the thermally conductive sheet of an aspect of the present invention is attached. This allows the thermally conductive sheet of an aspect of the present invention to have higher adhesion to an adherend.

The acrylic ester-based resin having the carboxyl group has a weight average molecular weight of preferably not more than 3,000,000, more preferably not more than 2,000,000, and even more preferably not more than 1, 500,000. In a case where the acrylic ester-based resin having the carboxyl group has a weight average molecular weight of not more than 3,000,000, it is easy for the organic polymer compound (B) to flow during attachment of the thermally conductive sheet of an aspect of the present invention in a hot press machine. This allows the thermally conductive sheet of an aspect of the present invention to have higher wettability to an adherend bonded thereto and have higher adhesion to the adherend.

The weight average molecular weight can be measured with use of a calibration curve of standard polystyrene by, for example, gel permeation chromatography that targets the organic polymer compound (B) or the acrylic ester-based resin having the carboxyl group.

The acrylic ester-based resin having the carboxyl group has a molecular weight distribution (weight average molecular weight/number average molecular weight) of preferably 1.0 to 10.0.

The organic polymer compound (B) has a glass transition temperature (Tg) of preferably not higher than 0° C., more preferably not higher than −30° C., and even more preferably not higher than −60° C. In a case where the organic polymer compound (B) has a Tg of not higher than 0° C., it is easy for the organic polymer compound (B) to flow during attachment of the thermally conductive sheet of an aspect of the present invention in a hot press machine. This allows the thermally conductive sheet of an aspect of the present invention to have higher wettability to an adherend bonded thereto and have higher adhesion to the adherend. The Tg of the organic polymer compound (B) has a lower limit that is exemplified by, but not particularly limited to, not lower than −150° C.

The acrylic ester-based resin having the carboxyl group has a glass transition temperature (Tg) of preferably not higher than 0° C., more preferably not higher than −30° C., and even more preferably not higher than −60° C. In a case where the acrylic ester-based resin having the carboxyl group has a Tg of not higher than 0° C., it is easy for the organic polymer compound (B) to flow during attachment of the thermally conductive sheet of an aspect of the present invention in a hot press machine. This allows the thermally conductive sheet of an aspect of the present invention to have higher wettability to an adherend bonded thereto and have higher adhesion to the adherend. The Tg of the acrylic ester-based resin having the carboxyl group has a lower limit that is exemplified by, but not particularly limited to, not lower than −150° C.

The Tg can be calculated by, for example, a method described in Examples.

### (Composition)

In an embodiment of the present invention, the composition containing the graphite particles (A) and the organic polymer compound (B) may contain, if necessary, an additive(s) such as a curing agent, a flame retardant, an anti-aging agent, a thermal stabilizer, a colorant, an antistatic agent, a tackifier, and/or a filler different from the graphite particles (A). In a conductive sheet production process, the graphite particles (A), the organic polymer compound (B), and the additive(s) are sometimes mixed with a solvent to form a primary sheet. However, in the present specification, the term “composition” means a composition obtained after a solvent is removed by, for example, drying, i.e., a composition contained in a thermally conductive sheet that is finally obtained.

Examples of the flame retardant include a bromine-based flame retardant, a phosphorus-based flame retardant, and an inorganic flame retardant. The flame retardant may be one type of flame retardant or two or more types of flame retardants. A content of the flame retardant content is preferably 1 part by weight to 300 parts by weight relative to 100 parts by weight of the organic polymer compound (B).

The curing agent is exemplified by, but not particularly limited to, bisphenol-type epoxy, biphenyl-type epoxy, stilbene-type epoxy, and naphthalene-type epoxy. The curing agent may be one type of curing agent or two or more types of curing agents.

### [1-2. Thermally Conductive Sheet]

The thermally conductive sheet of an aspect of the present invention contains the composition, and the graphite particles (A) are oriented in a thickness direction of the thermally conductive sheet.

### (Orientation of Graphite Particles (A))

The graphite particles (A) being oriented in the thickness direction of the thermally conductive sheet allows the thermally conductive sheet of an aspect of the present invention to have higher thermal conductivity in the thickness direction in which the graphite particles (A) are oriented. This reduces thermal resistance in the thickness direction in which the graphite particles (A) are oriented. In the thermally conductive sheet of an aspect of the present invention, not all the graphite particles (A) contained in the thermally conductive sheet need to be oriented in the thickness direction of the thermally conductive sheet. In the thermally conductive sheet of an aspect of the present invention, it is only necessary that at least some of the graphite particles (A) be oriented in the thickness direction of the thermally conductive sheet, and it is possible to improve thermal conductivity in the thickness direction in which the graphite particles (A) are oriented.

The graphite particles (A) being oriented in the thickness direction of the thermally conductive sheet means that an angle of a six-membered carbon ring surface in a crystal of the graphite particles (A) to a sheet surface of the thermally conductive sheet is more than 45°. The angle is more preferably not less than 50°, even more preferably not less than 70°, and particularly preferably not less than 80°. Note that except for a case where two angles formed between the six-membered carbon ring surface and the sheet surface of the thermally conductive sheet are 90°, the angle of the six-membered carbon ring surface to the sheet surface of the thermally conductive sheet is intended to mean a smaller angle. In the graphite particles (A), the six-membered carbon ring surface in the crystal of the graphite particles (A) is oriented in a surface direction of a scale or a flake in the case of the graphite particles (A) having a plate-like shape such as a scale-like shape or a flaky shape, and is oriented in a major axis direction of particles in the case of the graphite particles (A) having a spheroidal shape, a needle shape, a rod shape, a fibrous shape, or an irregular shape. Note that a direction of the major axis of the graphite particles (A) matches a direction of the maximum length of the graphite particles (A).

The angle of the six-membered carbon ring surface in the crystal of the graphite particles (A) to the sheet surface, which is a surface of the thermally conductive sheet, can be measured by using a scanning electron microscope to observe a cross section of the thermally conductive sheet in the thickness direction. First, a thin film section of a central part of the thermally conductive sheet in the thickness direction is produced. Then, the scanning electron microscope is used to observe the graphite particles (A) in the thin film section and measure an angle formed between the major axis of any 20 graphite particles (A) and the sheet surface, so that the angle of the six-membered carbon ring surface in the crystal of the graphite particles (A) to the sheet surface can be determined. In the present specification, the foregoing angles of not less than 45°, not less than 50°, not less than 70°, and not less than 80° each mean that an average of values measured as described above is not less than a corresponding angle. In a case where an angle formed between the major axis of the graphite particles (A) and the sheet surface is more than 90°, a supplementary angle to the angle is regarded as a measurement value.

(Physical Properties, Etc. Of Thermally Conductive Sheet)

The thermally conductive sheet of an aspect of the present invention has a thermal resistance of preferably not more than 0.10° C./W, more preferably not more than 0.09° C./W, even more preferably not more than 0.085° C./W, and particularly preferably not more than 0.082° C./W. Note here that in the present specification, thermal resistance refers to thermal conduction in the thickness direction of the thermally conductive sheet and refers to a thermal resistance value measured by a method described in Examples. In a case where the thermal resistance is not more than 0.10° C./W, the thermally conductive sheet has excellent thermal conductivity and has excellent heat dissipation characteristics when the thermally conductive sheet is interposed between a heat-generating body and a heat-dissipating body and used as a heat dissipation device. The thermal resistance that is lower is preferable.

The thermally conductive sheet of an aspect of the present invention has a thickness of preferably not more than 300 μm, more preferably not more than 200 μm, further more preferably not more than 140 μm, even more preferably not more than 110 μm, still more preferably not more than 95 μm, and particularly preferably not more than 80 μm. Note here that in the present specification, the thickness of the thermally conductive sheet refers to a thickness measured by a method described in Examples. The thermally conductive sheet that has a thickness of not more than 300 μm or not more than 200 μm is preferable because such a thermally conductive sheet can be attached to a heat-generating body such as an electronic component even in a narrow space. As long as the thermally conductive sheet exhibits a function as a thermally conductive sheet, the thickness of the thermally conductive sheet has a lower limit that is also not particularly limited and that is preferably not less than 10 μm, and more preferably not less than 20 μm.

A sulfur content of the thermally conductive sheet of an aspect of the present invention is preferably not more than 0.30% by weight, more preferably not more than 0.25% by weight, even more preferably not more than 0.20% by weight, and particularly preferably not more than 0.10% by weight, relative to a total weight of the thermally conductive sheet. Note here that in the present specification, the sulfur content of the thermally conductive sheet refers to a sulfur content measured by a method described in Examples. In a case where the sulfur content of the thermally conductive sheet is not more than 0.30% by weight, it is possible to more suitably reduce moisture absorbency of the thermally conductive sheet consequently further improve adhesion to an adherend. The sulfur content of the thermally conductive sheet is preferably lower and has a lower limit that is exemplified by, but not particularly limited to, not less than 0.01% by weight.

A content of the graphite particles (A) relative to the total weight of the thermally conductive sheet in the thermally conductive sheet of an aspect of the present invention is preferably not less than 40.0% by weight, more preferably not less than 45.0% by weight, even more preferably not less than 47.5% by weight, and still more preferably not less than 50.0% by weight. In a case where the content of the graphite particles (A) is not less than 40.0% by weight or not less than 45.0% by weight, sufficient thermal conductivity is suitably exhibited in the thermally conductive sheet of an aspect of the present invention.

The content of the graphite particles (A) relative to the total weight of the thermally conductive sheet is preferably not more than 70.0% by weight, more preferably not more than 65.0% by weight, and even more preferably not more than 60.0% by weight. In a case where the content of the graphite particles (A) is not more than 70.0% by weight, sufficient flexibility and adhesion are suitably exhibited in the thermally conductive sheet of an aspect of the present invention.

A content of the organic polymer compound (B) relative to the total weight of the thermally conductive sheet in the thermally conductive sheet of an aspect of the present invention is preferably not less than 10% by weight, more preferably not less than 15% by weight, and even more preferably not less than 20% by weight. In a case where the content of the organic polymer compound (B) is not less than 10% by weight, it is possible to improve flexibility of the thermally conductive sheet of an aspect of the present invention and allow good adhesion between a heat-generating body and a heat-dissipating body via the thermally conductive sheet. The content of the organic polymer compound (B) relative to the total weight of the thermally conductive sheet is preferably not more than 60% by weight, more preferably not more than 50% by weight, and even more preferably not more than 40% by weight.

In an embodiment of the present invention, a content of the carboxyl group in the organic polymer compound (B) relative to the weight of the graphite particles (A) is preferably not less than 0.0014 mmol/g, more preferably not less than 0.01 mmol/g, and even more preferably not less than 0.08 mmol/g. In a case where the content of the carboxyl group in the organic polymer compound (B) relative to the weight of the graphite particles (A) is not less than 0.0014 mmol/g, it is possible to suitably improve graphite binding capacity.

The content of the carboxyl group in the organic polymer compound (B) relative to the weight of the graphite particles (A) is preferably not more than 0.55 mmol/g, more preferably not more than 0.40 mmol/g, and even more preferably not more than 0.37 mmol/g. In a case where the content of the carboxyl group in the organic polymer compound (B) relative to the weight of the graphite particles (A) is not more than 0.55 mmol/g, it is possible to suitably improve adhesion to an adherend.

In an embodiment of the present invention, the percentage of the weight of the graphite particles (A) to the weight of the organic polymer compound (B) is preferably not more than 3.0, and more preferably not more than 2.0. The percentage of the weight of the graphite particles (A) to the weight of the organic polymer compound (B) is preferably not less than 0.25, and more preferably not less than 0.33.

In a case where the thermally conductive sheet of an aspect of the present invention contains the tackifier, a content of the tackifier need only not impair an effect of the present invention and is not particularly limited. A preferable content of the tackifier is, for example, not more than 40% by weight relative to the weight of the organic polymer compound (B).

In a case where the thermally conductive sheet of an aspect of the present invention contains the curing agent, a content of the curing agent need only not impair an effect of the present invention and is not particularly limited. A preferable content of the curing agent is, for example, not more than 0.20% by weight relative to the total weight of the thermally conductive sheet.

Note that the content of the graphite particles (A), the organic polymer compound (B), sulfur, and the additive(s) in the foregoing thermally conductive sheet of an aspect of the present invention can be the same as the content of the graphite particles (A), the organic polymer compound (B), sulfur, and the additive(s) in the composition relative to the total weight of the composition.

In the present specification, hardness of the thermally conductive sheet of an aspect of the present invention is substituted by a value of a laminate before slicing. The thermally conductive sheet of an aspect of the present invention has a hardness of preferably not less than 75, more preferably not less than 80, and even more preferably not less than 84, at 20° C. Note here that in the present specification, the hardness at 20° C. of the thermally conductive sheet refers to a hardness measured by a method described in Examples. The thermally conductive sheet that has a hardness of not less than 75 at 20° C. is preferable because such a thermally conductive sheet is sufficiently hard and thus can be sliced to have a small thickness. The thermally conductive sheet has a hardness of preferably not more than 95, more preferably not more than 92, and even more preferably not more than 90, at 20° C. The thermally conductive sheet that has a hardness of not more than 95 at 20° C. allows the thermally conductive sheet to be less deformed when bonded to an adherend by hot pressing and allows sufficient adhesion of the thermally conductive sheet to a component with which the thermally conductive sheet is in contact. Further, a state in which the graphite particles (A) contained in the thermally conductive sheet are oriented in the thickness direction can be maintained in a case where the thermally conductive sheet is bonded to the adherend by hot pressing. It is therefore possible to successfully transfer heat and sufficiently relax thermal stress.

The thermally conductive sheet of an aspect of the present invention has a hardness of preferably more than 60, more preferably not less than 63, and even more preferably not less than 65, at 70° C. Note here that in the present specification, the hardness at 70° C. of the thermally conductive sheet refers to a hardness measured by a method described in Examples. The thermally conductive sheet that has a hardness of more than 60 at 70° C. is preferable because such a thermally conductive sheet is sufficiently hard and thus can be sliced to have a small thickness. The thermally conductive sheet has a hardness of preferably not more than 80, more preferably not more than 78, and even more preferably not more than 75, at 70° C. The thermally conductive sheet that has a hardness of not more than 80 at 70° C. allows the thermally conductive sheet to be less deformed when bonded to an adherend by hot pressing and allows sufficient adhesion of the thermally conductive sheet to a component with which the thermally conductive sheet is in contact. Further, a state in which the graphite particles (A) contained in the thermally conductive sheet are oriented in the thickness direction can be maintained in a case where the thermally conductive sheet is bonded to the adherend by hot pressing. It is therefore possible to successfully transfer heat and sufficiently relax thermal stress.

In the present specification, a numerical value (unit: N·mm) representing tackiness measured by a method described in Examples can be used to evaluate tackiness of the thermally conductive sheet. The tackiness of the thermally conductive sheet of an aspect of the present invention is preferably not less than 0.8 N·mm, more preferably not less than 1.0 N·mm, and even more preferably not less than 1.2 N·mm. The tackiness has an upper limit that can be exemplified by, but is not particularly limited to, less than 5.0 N·mm.

In a case where the tackiness of the thermally conductive sheet is not less than 0.8 N·mm, highly accurate positioning can be achieved when the thermally conductive sheet is temporarily bonded to an adherend. Further, positional displacement does not occur even in a case where the adherend is moved while being temporarily bonded to the thermally conductive sheet. In view of the above, in a case where the tackiness of the thermally conductive sheet of an aspect of the present invention is not less than 0.8 N·mm, more excellent adhesion can be exhibited when hot pressing is carried out. In a case where the tackiness of the thermally conductive sheet is less than 5.0 N·mm, air between the thermally conductive sheet and an adherend easily escapes when the thermally conductive sheet is temporarily bonded to the adherend. Furthermore, during bonding of the thermally conductive sheet and the adherend by hot pressing, air entrained between the thermally conductive sheet and the adherend easily escapes. In view of the above, in a case where the tackiness of the thermally conductive sheet of an aspect of the present invention is less than 5.0 N·mm, it is possible to achieve more sufficient adhesion of the thermally conductive sheet of an aspect of the present invention to a component with which the thermally conductive sheet is in contact.

### [2. Method for Producing Thermally Conductive Sheet]

A method for producing the thermally conductive sheet of an aspect of the present invention is not particularly limited provided that the method makes it possible to produce the foregoing thermally conductive sheet. Examples of the method include a method for producing the thermally conductive sheet in accordance with an embodiment of the present invention (described later) (hereinafter referred to as “production method of an aspect of the present invention”).

The production method of an aspect of the present invention includes: a primary sheet forming step of forming, in sheet form, a composition containing graphite particles (A) and an organic polymer compound (B), to obtain a primary sheet in which the graphite particles (A) are oriented in a direction parallel to a sheet surface; a laminate forming step of laminating the primary sheet to obtain a primary sheet laminate; and a slicing step of slicing a laminate cross section of the primary sheet laminate to obtain a thermally conductive sheet, the organic polymer compound (B) containing an acrylic ester-based resin having a carboxyl group, and a content of the carboxyl group in the organic polymer compound (B) relative to a total weight of the organic polymer compound (B) being not less than 0.010 mmol/g and not more than 0.410 mmol/g.

### (Primary Sheet Forming Step)

In the primary sheet forming step, a composition containing graphite particles (A) and an organic polymer compound (B) is formed in sheet form to obtain a primary sheet in which the graphite particles (A) are oriented in a direction parallel to a sheet surface.

Note here that the graphite particles (A), the organic polymer compound (B), and the composition containing the graphite particles (A) and the organic polymer compound (B) are as described in the above [1. Thermally conductive sheet] section.

Examples of a method in which the composition is formed in sheet form to obtain a primary sheet in which the graphite particles (A) are oriented in a direction parallel to a sheet surface include methods shown in (a) and (b) below.

(a) The graphite particles (A), the organic polymer compound (B), and, if necessary, the foregoing additive(s) are mixed with or without a solvent added to obtain a mixture.

(b) The mixture obtained in (a) is formed in sheet form to produce a primary sheet in which the graphite particles (A) are oriented in a direction substantially parallel to a main surface.

Examples of the solvent include: aromatic hydrocarbon solvents such as toluene and xylene; ester-based solvents such as ethyl acetate and butyl acetate; ketone-based solvents such as methyl ethyl ketone and methyl isobutyl ketone (MIBK); and cellosolve-based solvents such as butyl cellosolve, phenyl cellosolve, and dimethyl cellosolve. The solvent may be one type of solvent or a mixture of two or more types of solvents. The amount of the solvent is preferably such that the total concentration of the graphite particles (A), the organic polymer compound (B), and the additive(s) is 10% by weight to 50% by weight, and is more preferably such that the total concentration of the graphite particles (A), the organic polymer compound (B), and the additive(s) is 20% by weight to 40% by weight. The primary sheet that is produced at this concentration is preferable because there is a moderate space between the graphite particles, so that orientation of the particles is improved during sheet production and lamination pressing.

A method in which the graphite particles (A), the organic polymer compound (B), and, if necessary, the foregoing additive(s) are mixed with or without a solvent added is not particularly limited. Examples of the method include a method in which the organic polymer compound (B) is dissolved in a solvent, and a resulting mixture is mixed with the graphite particles (A) and, if necessary, another additive added thereto. A mixing method is also not particularly limited and can be, for example, mixing by stirring, roll kneading, mixing with a kneader, mixing with a Brabender mixer, or mixing with an extruder.

A method in which a resulting mixture is subsequently formed in sheet form is also not particularly limited and can be, for example, a method for producing a primary sheet by roll molding, press molding, extrusion molding, or coating. In a case where a solvent is used during mixing, the added solvent need only be removed by, for example, drying before or after a mixture is formed in sheet form.

The thickness of the composition formed in sheet form is preferably not less than 20 times, and more preferably 20 times to 100 times the average of the maximum length or the major axis of the graphite particles (A). The thickness that is in the above range makes it possible to obtain a high strength sheet and thus is preferable.

### (Laminate Forming Step)

The laminate forming step is a step of laminating the primary sheet to obtain a primary sheet laminate. A method for laminating the primary sheet is exemplified by, but not particularly limited to, a method of stacking a plurality of primary sheets and a method of folding a primary sheet. The primary sheet is preferably laminated with the graphite particles (A) aligned in the sheet surface.

Pressure at which the primary sheet is laminated is not particularly limited and need only be adjusted to be so weak as not to break a slice surface in a subsequent slicing step and so strong as to achieve successful adhesion between primary sheets. Further, heating as lamination may be carried out under appropriate.

The pressure at which the primary sheet is laminated may be applied every time each single primary sheet is laminated, may be applied for each plurality of primary sheets, or may be applied after all primary sheets are stacked. Preferable examples of a method for applying the pressure include a method in which pressure is applied every time each single primary sheet or a plurality of primary sheets is/are laminated/stacked and pressure is applied after all primary sheets are stacked. In such a case, pressure and temperature that are applied every time each single primary sheet or a plurality of primary sheets is/are laminated/stacked are not particularly limited. For example, the pressure is 1 kgf/cm² to 100 kgf/cm², and the temperature is 20° C. to 200° C. Pressure and temperature that are applied after all primary sheets are stacked are also not particularly limited, For example, the pressure is 1 kgf/cm² to 100 kgf/cm², and the temperature is 20° C. to 200° C.

### (Slicing Step)

In the slicing step, a laminate cross section of the primary sheet laminate is sliced to obtain a thermally conductive sheet. An angle at which the laminate cross section of the primary sheet laminate is sliced is not particularly limited.

A method for slicing the primary sheet laminate is exemplified by, but not particularly limited to, a multi-blade method, a laser processing method, a water jet method, a knife processing method, and an ultrasonic processing method.

### <Recap>

An embodiment of the present invention includes the following features.

<1> A thermally conductive sheet containing a composition containing graphite particles (A) and an organic polymer compound (B),
the graphite particles (A) being oriented in a thickness direction of the thermally conductive sheet,
the organic polymer compound (B) containing an acrylic ester-based resin having a carboxyl group, and
a content of the carboxyl group in the organic polymer compound (B) relative to a total weight of the organic polymer compound (B) being not less than 0.010 mmol/g and not more than 0.410 mmol/g.
   <2> The thermally conductive sheet according to <1>, wherein the organic polymer compound (B) has a weight average molecular weight of not less than 100,000.
   <3> The thermally conductive sheet according to <1> or <2>, wherein the organic polymer compound (B) has a glass transition temperature (Tg) of not higher than 0° C.
   <4> The thermally conductive sheet according to any one of <1> to <3>, wherein a curing agent content relative to a total weight of the thermally conductive sheet is not more than 0.20% by weight.
   <5> The thermally conductive sheet according to any one of <1> to <4>, wherein a sulfur content relative to a total weight of the thermally conductive sheet is not more than 0.30% by weight.
   <6> The thermally conductive sheet according to any one of <1> to <5>, wherein a content of the graphite particles (A) relative to a total weight of the thermally conductive sheet is not less than 40.0% by weight and not more than 70.0% by weight.
   <7> The thermally conductive sheet according to any one of <1> to <6>, wherein a content of the organic polymer compound (B) relative to a total weight of the thermally conductive sheet is not less than 10% by weight and not more than 60% by weight.
   <8> The thermally conductive sheet according to any one of <1> to <7>, wherein a content of the acrylic ester-based resin having the carboxyl group relative to the total weight of the organic polymer compound (B) is not less than 40% by weight and not more than 90% by weight.
   <9> The thermally conductive sheet according to any one of <1> to <8>, further containing 1 part by weight to 300 parts by weight of a flame retardant relative to 100 parts by weight of the organic polymer compound (B).
   <10> The thermally conductive sheet according to any one of <1> to <9>, wherein the content of the carboxyl group in the organic polymer compound (B) relative to a weight of the graphite particles (A) is not less than 0.0014 mmol/g and not more than 0.55 mmol/g.
   <11> A method for producing a thermally conductive sheet, including:
a primary sheet forming step of forming, in sheet form, a composition containing graphite particles (A) and an organic polymer compound (B), to obtain a primary sheet in which the graphite particles (A) are oriented in a direction parallel to a sheet surface;
a laminate forming step of laminating the primary sheet to obtain a primary sheet laminate; and
a slicing step of slicing a laminate cross section of the primary sheet laminate to obtain a thermally conductive sheet,
the organic polymer compound (B) containing an acrylic ester-based resin having a carboxyl group, and
a content of the carboxyl group in the organic polymer compound (B) relative to a total weight of the organic polymer compound (B) being not less than 0.010 mmol/g and not more than 0.410 mmol/g, and
the organic polymer compound (B) having a weight average molecular weight of not less than 30,000.
   <12> The method according to <11>, wherein the primary sheet forming step is a step of forming the primary sheet by coating.

The present invention is not limited to the embodiments, but can be altered by a skilled person in the art within the scope of the claims. The present invention also encompasses, in its technical scope, any embodiment derived by combining technical means disclosed in differing embodiments.

### EXAMPLES

The following description will discuss an embodiment of the present invention in more detail with reference to Examples and Comparative Examples. Note, however, that the present invention is not limited to these examples.

The following evaluation and production of thermally conductive sheets were carried out at normal temperature (20° C.) and normal pressure (1 atm), unless otherwise stated.

### [Method for Measuring Physical Properties, etc.]

Evaluation methods in Examples and Comparative Examples will be described below.

### <Weight Average Molecular Weight: Gel Permeation Chromatography (GPC) Analysis>

A GPC device (manufacturer: Tosoh Corporation, product name: HLC-8420, column: TSKgel GMH_{XL}×2+TSKgel G3000H_{XL}+TSKgel G2000H_{XL}, eluate: tetrahydrofuran (THF)) was used to carry out GPC analysis to measure a weight average molecular weight (Mw) of the organic polymer compound (B) used in Examples.

### <Content of Carboxyl Group of an Aspect of the Present Invention>

### (Identification of Each Monomer Constituting Organic Polymer Compound (B))

A pyrolysis GC/MS measurement device (product name: JCI-22, manufactured by Japan Analytical Industry Co., Ltd.) was used to pyrolyze the organic polymer compound (B) used in Examples into monomers constituting the organic polymer compound (B), and gas chromatography was used to identify a type of each of the monomers.

### (¹HNMR Analysis)

The organic polymer compound (B) was dissolved in deuterated chloroform (CDCl₃) to prepare an NMR measurement sample. For the NMR measurement sample, an NMR measurement device (product name: AVA700, manufactured by Bruker Corporation) was used to measure ¹HNMR to obtain a ¹HNMR spectrum. A ratio (mmol/g) of monomers having a carboxyl group contained in the organic polymer compound (B) to the total weight of the organic polymer compound (B) was calculated on the basis of a peak intensity of a peak in the obtained ¹HNMR spectrum which peak is derived from each of the monomers. Note here that the calculated ratio was regarded as the content of the carboxyl group of an aspect of the present invention because the substance amount of a monomer having the carboxyl group and the substance amount of the carboxyl group are the same.

### <Glass Transition Temperature (Tg)>

Since the organic polymer compound (B) used in Examples is composed of an acrylic ester-based resin that is a copolymer and that has a carboxyl group, a glass transition temperature (Tg) thereof was calculated with use of a FOX equation shown in Equation (3) below. Note that known values were used as Tg₁, Tg₂, . . . . Tgₙ described later.

$$( 1 / Tg ) = ( {C}_{1} / {Tg}_{1} ) + ( {C}_{2} / {Tg}_{2} ) + … ( {C}_{n} / {Tg}_{n} ) \qquad ( 3 )$$

(where Tg₁, Tg₂, . . . . Tgₙ are each Tg of a homopolymer composed of monomers constituting the copolymer. C₁, C₂ . . . . Cₙ are respective weight ratios of the monomers to the weight of all the monomers.)

### <Graphite Binding Capacity>

After laminates of Examples (described later) and Comparative Examples (described later) were produced, a state of a laminate sliced was visually observed, and graphite binding capacity of a thermally conductive sheet was evaluated by the following criteria:
A (excellent): a case where the shape of a laminate produced and then sliced was maintained, and it was possible to slice the laminate
B (good): a case where a laminate produced and then sliced was deformed, but it was possible to slice the laminate
C (poor): a case where it is impossible to maintain the shape of a rectangular parallelepiped immediately after production of a laminate or a case where a laminate produced and then sliced was deformed, and it was impossible to slice the laminate

### <Thickness>

A 3 mm square piece was cut out from a thermally conductive sheet and used as an evaluation sample. The thickness in four corner parts and one central part of the evaluation sample was measured with use of a micrometer manufactured by Mitutoyo Corporation, and an average of obtained measurement values was regarded as the thickness of the thermally conductive sheet. Note here that “one central part” refers to the position of an intersection of two diagonal lines when diagonal lines are drawn from the four corner parts to diagonally located measurement sites.

### <Hardness>

A laminate consisting of only a thermally conductive sheet (laminate before slicing) was used as an evaluation sample for hardness of the thermally conductive sheet to evaluate the hardness at a center of a cross section (6.5 cm×6.5 cm) of the laminate. Note that the laminate is, in more detail, a laminate which is obtained by operations described in <Preparation of laminate> (described later) and which has not been subjected to operations described in <Preparation of thermally conductive sheet>. Specifically, hardness at the center of the cross section of the evaluation sample was measured in accordance with the Asker C method of the Society of Rubber Industry, Japan Standard (SRIS) with use of a hardness meter (ASKER CL-150LJ, manufactured by KOBUNSHI KEIKI CO., LTD.). The hardness at 20° C. is a hardness measured by adjusting temperature so that a temperature measured by a surface thermometer of an evaluation sample is 20° C., and the hardness at 70° C. is a hardness measured by heating so that the temperature measured by the surface thermometer of the evaluation sample is 70° C.

The hardness at 20° C. of the thermally conductive sheet was evaluated by the following criteria:
A (excellent): not less than 84
B (good): not less than 80 and less than 84
C (poor): less than 80

The hardness at 70° C. of the thermally conductive sheet was evaluated by the following criteria:
A (excellent): more than 63
B (good): more than 60 and less than 63
C (poor): not more than 60

### <Thermal Resistance>

A 1 mm square piece was cut out from a thermally conductive sheet and used as an evaluation sample. For the evaluation sample, a thermal resistance value [cm²K/W] of the thermally conductive sheet was measured with use of a thermal resistance measurement device (resin material thermal resistance measurement device manufactured by Hitachi Technologies and Services, Ltd.) at a sample temperature of 50° C. and a pressure of 0.5 MPa.

The thermal resistance of the thermally conductive sheet was evaluated by the following criteria:
A (excellent): a case where the thermal resistance value of the thermally conductive sheet is not more than 0.080 cm²K/W
B (good): a case where the thermal resistance value of the thermally conductive sheet is more than 0.080 cm²K/W and not more than 0.10 cm²K/W
C (poor): a case where the thermal resistance value of the thermally conductive sheet is more than 0.10 cm²K/W

### <Tackiness>

At 20° C., a texture analyzer (product name: TA-XT plus 100C, manufactured by EKO INSTRUMENTS CO., LTD.) was used to measure a numerical value representing tackiness of a thermally conductive sheet to evaluate tackiness of thermally the conductive sheet. Specifically, the tackiness was evaluated with use of a 7-mm-diameter probe under the condition that test speeds were 0.5 mm/sec (before measurement), 0.1 mm/sec (during measurement), and 10 mm/sec (return), and a force of 40N was applied.
A (excellent): a case where the numerical value representing the tackiness is more than 2.0 N·mm and less than 5.0 N·mm
B (good): a case where the numerical value representing the tackiness is more than 0.7 N·mm and less than 2.0 N·mm
C (poor): a case where the numerical value representing the tackiness is not more than 0.7 N·mm

### <Adhesion>

Silicone (50 mm×50 mm×0.7 mm), a thermally conductive sheet (40 mm×40 mm×0.11 mm), and a spreader (nickel-plated copper: 50 mm×50 mm×2 mm) were stacked in this order on a heat press device and set. Subsequently, the heat press device was used to bond the silicone, the thermally conductive sheet, and the spreader in this order under conditions of 150° C. and 100 kg. This resulted in obtainment of an adhesion measurement laminate. Subsequently, Scanning Acoustic Tomograph (product name: FineSAT, manufactured by Hitachi Power Solutions Co., Ltd.) was used to measure an area of adhesion between the thermally conductive sheet and adherends (the silicone and the spreader) in the adhesion measurement laminate.

Adhesion of the thermally conductive sheet was evaluated by the following criteria:
A (excellent): a case where the area of adhesion is not less than 95% of the area of the entire surface on a side of the thermally conductive sheet which side adheres to the adherend
B (good): a case where the area of adhesion is not less than 90% and less than 95% of the area of the entire surface on the side of the thermally conductive sheet which side adheres to the adherend
C (poor): a case where the area of adhesion is less than 90% of the area of the entire surface on the side of the thermally conductive sheet which side adheres to the adherend

### Example 1

### <Preparation of Composition Solution>

A planetary centrifugal mixer was used to stir and mix raw materials (shown below) over 10 minutes to obtain a stirred mixture. A composition solution had a solid content concentration of 30.0% by weight.
As graphite particles, 120 g of scale-like graphite powder (average particle size: 73 μm, thickness: 0.80 μm, aspect ratio: 91, sulfur content: not more than 1.0% by weight) was used.
As an organic polymer compound, 360 g of a 15% by weight toluene/ethyl acetate solution containing an acrylic ester-based resin (weight average molecular weight: 400,000, Tg: −40° C., containing a carboxyl group as a functional group, content of the carboxyl group of an aspect of the present invention: 0.010 mmol/g, 0.56 KOHmg/g) (54.0 g as the acrylic ester-based resin) was used.
As a flame retardant, 66.0 g of bisphenol A bis (diphenyl phosphate) was used.
As toluene, toluene having an amount such that the solid content concentration of the composition solution would be 30.0% by weight was used.

### <Preparation of Primary Sheet>

The resulting composition solution was applied to and spread on a polyethylene terephthalate film, with a clearance provided, so that a coating film would have a thickness of 2 mm, the polyethylene terephthalate film having a mold release treated surface. Thereafter, a resulting sheet was dried at 120° C. for not less than 20 minutes, and the dried sheet was peeled off to obtain a primary sheet having a thickness of 2 mm. The above operation was repeated three times to produce three primary sheets.

The content of the graphite particles, the organic polymer compound, and the flame retardant relative to the total weight of the composition contained in the primary sheet corresponds to the content of the graphite particles, the organic polymer compound, and the flame retardant relative to the total weight of a composition contained in a thermally conductive sheet that is finally obtained, i.e., the thermally conductive sheet that is finally obtained.

### <Preparation of Laminate>

A 2.4 cm×6.4 cm sheet was cut out from each of the three primary sheets thus obtained. Every time 5 sheets were stacked in a container having an internal volume of 2.5 cm in length×6.5 cm in width×7.5 cm in height, the stacked sheets were pressed at normal temperature and a pressure of not less than 400 kg, and stacking and pressing were repeated until the pressed sheets had a thickness of not less than 6.5 cm after final pressing. Next, a laminate obtained by stacking the sheets until the thickness reached not less than 6.5 cm was heated at 120° C. for 15 minutes and then pressed at a pressure of not less than 400 kg, so that a laminate of 2.5 cm×6.5 cmx 6.5 cm was obtained.

### <Preparation of Thermally Conductive Sheet>

By slicing a laminate cross section of the obtained laminate at an angle of 45 degrees relative to a direction in which the sheets were stacked (in other words, in a direction normal to a main surface of the stacked primary sheets), a thermally conductive sheet was produced which had a size of 6.5 cm in length×6.5 cm in width 110 μm in thickness and in which the graphite particles were oriented in a thickness direction of the thermally conductive sheet.

### Examples 2 to 7 and Comparative Examples 1 to

Operations were carried out in the same manner as in Example 1 to produce a thermally conductive sheet, except that instead of the 15% by weight toluene/ethyl acetate solution containing the acrylic ester-based resin and used in Example 1, a 15% by weight toluene/ethyl acetate solution containing another acrylic ester-based resin having characteristics shown in Table 1 was used as the organic polymer compound. In Comparative Example 3, in a case where the laminate cross section of the laminate was sliced at an angle of 45 degrees relative to the direction in which the sheets were stacked, the laminate was deformed, so that it was impossible to slice the laminate. This prevented production of a thermally conductive sheet.

### Example 8

Operations were carried out in the same manner as in Example 1 to produce a thermally conductive sheet, except for matters shown in (i) to (iii) below. (i) Instead of the 15% by weight toluene/ethyl acetate solution containing the acrylic ester-based resin and used in Example 1, a 15% by weight toluene/ethyl acetate solution containing another acrylic ester-based resin having characteristics shown in Table 1 was used as the organic polymer compound.
(ii) The used amount of the organic polymer compound was changed to 326 g (48.9 g as the acrylic ester-based resin).
(iii) The used amount of the flame retardant was changed to 59.7 g.

### Example 9

Operations were carried out in the same manner as in Example 1 to produce a thermally conductive sheet, except for matters shown in (iv) to (vi) below. (iv) Instead of the 15% by weight toluene/ethyl acetate solution containing the acrylic ester-based resin and used in Example 1, a 15% by weight toluene/ethyl acetate solution containing another acrylic ester-based resin having characteristics shown in Table 1 was used as the organic polymer compound.
(v) The used amount of the organic polymer compound was changed to 295 g (44.2 g as the acrylic ester-based resin).
(vi) The used amount of the flame retardant was changed to 54.0 g.

### Comparative Example 4

A thermally conductive sheet was produced by the same method as in Example 1 of Patent Literature 2. In Comparative Example 4, a curing agent in addition to the graphite particles, the organic polymer compound, and the flame retardant was used to prepare a composition solution.

### Comparative Example 5

A thermally conductive sheet was produced by the same method as in Example 2 of Patent Literature 2. Also in Comparative Example 5, the curing agent in addition to the graphite particles, the organic polymer compound, and the flame retardant was used to prepare a composition solution.

### [Results]

Table 1 below shows (i) properties of the organic polymer compounds of the produced thermally conductive sheets, the properties having been measured in Examples 1 to 9 and Comparative Examples 1 to 5 by the foregoing methods and (ii) mixing ratios of the graphite particles, the organic polymer compound, the flame retardant, and the curing agent. In Table 1, the term “mixing ratio” means a content [% by weight] relative to the total weight of the thermally conductive sheet. Further, “functional group amount a” means the content [mmol/g] of the carboxyl group of an aspect of the present invention, and “functional group amount b” means the content [KOHmg/g] of the carboxyl group of an aspect of the present invention.

TABLE 1

| | | Example 1 | Example 2 | Example 3 | Example 4 |
|---|---|---|---|---|---|
| Graphite particles | Mixing ratio | 50.0 | 50.0 | 50.0 | 50.0 |
| | [% by weight] | | | | |
| Organic polymer | Functional | 0.010 | 0.094 | 0.178 | 0.410 |
| compound | group amount a | | | | |
| | Functional | 0.56 | 5.3 | 10.0 | 23.0 |
| | group amount b | | | | |
| | Tg [° C.] | −40 | −40 | −40 | −40 |
| | Mw | 400,000 | 400,000 | 400,000 | 400,000 |
| | Mixing ratio | 22.5 | 22.5 | 22.5 | 22.5 |
| | [% by weight] | | | | |
| Flame retardant | Mixing ratio | 27.5 | 27.5 | 27.5 | 27.5 |
| | [% by weight] | | | | |
| Curing agent | Mixing ratio | 0 | 0 | 0 | 0 |
| | [% by weight] | | | | |
| Mixing method | | Solution | Solution | Solution | Solution |
| | | mixing | mixing | mixing | mixing |
| Thermally | Graphite binding | B | A | A | A |
| conductive sheet | capacity | | | | |
| | Hardness at | B | B | B | B |
| | 20° C. | | | | |
| | Hardness at | B | B | B | B |
| | 70° C. | | | | |
| | Thermal | B | B | B | B |
| | resistance | | | | |
| | Tackiness | A | A | A | A |
| | Adhesion | B | B | B | B |

| | | Example 5 | Example 6 | Example 7 |
|---|---|---|---|---|
| Graphite particles | Mixing ratio | 50.0 | 50.0 | 50.0 |
| | [% by weight] | | | |
| Organic polymer | Functional | 0.094 | 0.094 | 0.357 |
| compound | group amount a | | | |
| | Functional | 5.3 | 5.3 | 20.0 |
| | group amount b | | | |
| | Tg [° C.] | −40 | −45 | −35 |
| | Mw | 600,000 | 600,000 | 600,000 |
| | Mixing ratio | 22.5 | 22.5 | 22.5 |
| | [% by weight] | | | |
| Flame retardant | Mixing ratio | 27.5 | 27.5 | 27.5 |
| | [% by weight] | | | |
| Curing agent | Mixing ratio | 0 | 0 | 0 |
| | [% by weight] | | | |
| Mixing method | | Solution | Solution | Solution |
| | | mixing | mixing | mixing |
| Thermally | Graphite binding | A | A | A |
| conductive sheet | capacity | | | |
| | Hardness at | B | B | B |
| | 20° C. | | | |
| | Hardness at | B | B | B |
| | 70° C. | | | |
| | Thermal | B | B | B |
| | resistance | | | |
| | Tackiness | A | A | A |
| | Adhesion | A | A | B |

| | | | | Comparative | Comparative |
|---|---|---|---|---|---|
| | | Example 8 | Example 9 | Example 1 | Example 2 |
| Graphite particles | Mixing ratio | 52.5 | 55.0 | 50.0 | 50.0 |
| | [% by weight] | | | | |
| Organic polymer | Functional | 0.094 | 0.094 | 0.690 | 0.420 |
| compound | group amount a | | | | |
| | Functional | 5.3 | 5.3 | 38.7 | 23.6 |
| | group amount b | | | | |
| | Tg [° C.] | −40 | −40 | −39 | −41 |
| | Mw | 650,000 | 650,000 | 530,000 | 550,000 |
| | Mixing ratio | 21.4 | 20.25 | 22.5 | 22.5 |
| | [% by weight] | | | | |
| Flame retardant | Mixing ratio | 26.1 | 24.75 | 27.5 | 27.5 |
| | [% by weight] | | | | |
| Curing agent | Mixing ratio | 0 | 0 | 0 | 0 |
| | [% by weight] | | | | |
| Mixing method | | Solution | Solution | Solution | Solution |
| | | mixing | mixing | mixing | mixing |
| Thermally | Graphite binding | A | A | A | A |
| conductive sheet | capacity | | | | |
| | Hardness at | A | A | B | B |
| | 20° C. | | | | |
| | Hardness at | A | A | B | B |
| | 70° C. | | | | |
| | Thermal | A | A | B | B |
| | resistance | | | | |
| | Tackiness | A | B | A | A |
| | Adhesion | A | A | C | C |

| | | Comparative | Comparative | Comparative |
|---|---|---|---|---|
| | | Example 3 | Example 4 | Example 5 |
| Graphite particles | Mixing ratio | 50.0 | 53.9 | 53.9 |
| | [% by weight] | | | |
| Organic polymer | Functional | 0 | 0.690 | 0.420 |
| compound | group amount a | | | |
| | Functional | 0 | 38.7 | 23.6 |
| | group amount b | | | |
| | Tg [° C.] | −40 | −39 | −41 |
| | Mw | 400,000 | 530,000 | 550,000 |
| | Mixing ratio | 22.5 | 22.6 | 23.5 |
| | [% by weight] | | | |
| Flame retardant | Mixing ratio | 27.5 | 21.1 | 21.1 |
| | [% by weight] | | | |
| Curing agent | Mixing ratio | 0 | 2.4 | 1.5 |
| | [% by weight] | | | |
| Mixing method | | Solution | Melting and | Melting and |
| | | mixing | kneading | kneading |
| Thermally | Graphite binding | C | B | B |
| conductive sheet | capacity | | | |
| | Hardness at | —* | C | C |
| | 20° C. | | | |
| | Hardness at | —* | C | C |
| | 70° C. | | | |
| | Thermal | —* | C | C |
| | resistance | | | |
| | Tackiness | —* | A | A |
| | Adhesion | —* | C | C |

*“—” in Comparative Example 3 means that failure to produce a thermally conductive sheet made it impossible to measure physical properties thereof.

A scanning g electron microscope (product name: ULTRAplus manufactured by Carl Zeiss AG) was used to observe, at a magnification of 50 times to 4,000 times, the thermally conductive sheets produced in Examples 1 to 9. As a result, the graphite particles were observed to be oriented in a thickness direction of the thermally conductive sheets.

In view of the foregoing matter and the description in the column “Functional group amount a” in Table 1, the thermally conductive sheets produced in Examples 1 to 9 fall under the thermally conductive sheet of an aspect of the present invention. Further, in view of the descriptions in Examples 1 to 9 and the description in the column “Functional group amount a” in Table 1, a method for producing the thermally conductive sheets in Examples 1 to 9 falls under the production method of an aspect of the present invention. In contrast, a method for producing the thermally conductive sheets in Comparative Examples 1 to 5 does not fall under the production method of an aspect of the present invention, and the thermally conductive sheets produced in Comparative Examples 1 to 5 do not fall under the thermally conductive sheet of an aspect of the present invention.

As shown in Table 1, the thermally conductive sheets produced in Comparative Examples 1 to 5 are poor due to deterioration either in graphite binding capacity or in adhesion to an adherend, whereas the thermally conductive sheets produced in Examples 1 to 9 are excellent both in graphite binding capacity and in adhesion to an adherend.

Thus, it has turned out that the thermally conductive sheet of an aspect of the present invention has high graphite binding capacity and excellent adhesion to an adherend. It has also turned out that the production method of an aspect of the present invention makes it possible to produce the thermally conductive sheet of an aspect of the present invention which thermally conductive sheet has high graphite binding capacity and excellent adhesion to an adherend. It has therefore turned out that an aspect of the present invention brings about an effect of making it possible to provide a thermally conductive sheet which has high graphite binding capacity and excellent adhesion to an adherend.

The sulfur content of the graphite particles used in Examples 1 to 9 and Comparative Examples 1 to 3 was not more than 1.0% by weight. In contrast, the sulfur content of the graphite particles used in Comparative Examples 4 and 5 was more than 3.0% by weight. It has been confirmed that, as compared with the thermally conductive sheets described in Comparative Examples 4 and 5, the thermally conductive sheets described in Examples 1 to 9 and Comparative Examples 1 to 3 are less likely to corrode an electronic component which is in contact with a thermally conductive sheet.

### INDUSTRIAL APPLICABILITY

An embodiment of the present invention can be suitably used to produce (i) a thermally conductive sheet that has high graphite binding capacity and excellent adhesion to an adherend and (ii) a product in which the thermally conductive sheet is used, such as an electronic component including, for example, a multilayer wiring board and a semiconductor package.

1. A thermally conductive sheet comprising:
a composition including graphite particles and an organic polymer compound,
the graphite particles being oriented in a thickness direction of the thermally conductive sheet,
the organic polymer compound including an acrylic ester-based resin having a carboxyl group, and
a content of the carboxyl group in the organic polymer compound relative to a total weight of the organic polymer compound being from 0.010 mmol/g to 0.410 mmol/g.

2. The thermally conductive sheet according to claim 1, wherein
the organic polymer compound has a weight average molecular weight of not less than 100,000.

3. The thermally conductive sheet according to claim 1, wherein
the organic polymer compound has a glass transition temperature of not higher than 0° C.

4. The thermally conductive sheet according to claim 1, wherein a curing agent content relative to a total weight of the thermally conductive sheet is not more than 0.20% by weight.

5. The thermally conductive sheet according to claim 1, wherein a sulfur content relative to a total weight of the thermally conductive sheet is not more than 0.30% by weight.

6. The thermally conductive sheet according to claim 1, wherein
a content of the graphite particles relative to a total weight of the thermally conductive sheet is from 40.0% by weight to 70.0% by weight.

7. The thermally conductive sheet according to claim 1, wherein
a content of the organic polymer compound relative to a total weight of the thermally conductive sheet is from 10% by weight to 60% by weight.

8. The thermally conductive sheet according to claim 1, wherein
a content of the acrylic ester-based resin having the carboxyl group relative to the total weight of the organic polymer compound is from 40% by weight to 90% by weight.

9. The thermally conductive sheet according to claim 1, further comprising:
1 part by weight to 300 parts by weight of a flame retardant relative to 100 parts by weight of the organic polymer compound.

10. The thermally conductive sheet according to claim 1, wherein
the content of the carboxyl group in the organic polymer compound relative to a weight of the graphite particles is from 0.0014 mmol/g to 0.55 mmol/g.

11. A method for producing a thermally conductive sheet, comprising:
forming, in sheet form, a composition including graphite particles and an organic polymer compound, to obtain a primary sheet in which the graphite particles are oriented in a direction parallel to a sheet surface;
laminating the primary sheet to obtain a primary sheet laminate; and
slicing a laminate cross section of the primary sheet laminate to obtain a thermally conductive sheet,
the organic polymer compound including an acrylic ester-based resin having a carboxyl group, and
a content of the carboxyl group in the organic polymer compound relative to a total weight of the organic polymer compound being from 0.010 mmol/g to 0.410 mmol/g.

12. The method according to claim 11, wherein
the primary sheet forming forms the primary sheet by coating.
